(19) United States
(12) Patent Application Publication
(10) Pub. No.: US 2005/0267771 A1
(43) Pub. Date: Dec. 1, 2005

(54) Apparatus, system and method for integrated lifecycle management of a facility

(76) Inventors: Mitchell Joseph Biondi, Missouri City, TX (US); Thomas Raymond Hren, Houston, TX (US)

Correspondence Address: Ronald L. Chichester;Baker Botts L.L.P., Suite 3520, One Shell Plaza, Houston, TX, 77002-4995, US

(21) Appl. No.: 10/855,272

(22) Filed: May 27, 2004

(51) Int. Cl. G06F 17/60

(52) U.S. Cl. 705/1

(57) ABSTRACT

A method and system are provided for managing the lifecycle of a facility. The method and system are applicable for small or large-scale operations, such as those conducted by multiple organizations. Facilities are provided within the system for enabling information about the facility to be stored, searched, and retrieved by any of the organizations involved. The method enables the integration of lifecycle events so that information learned early in the lifecycle can be applied at later events in the same lifecycle, or for lifecycles of subsequent facilities.

### BACKGROUND

The present disclosure relates to facilities. More specifically, the present invention relates to managing all aspects of the lifecycle of a facility, from initial conception to decommission.

Facilities are expensive items for many corporations and governments. The capital and/or labor required to create and to maintain a physical facility can be a substantial investment for the company or government agency. Moreover, the way that facilities are designed, and how well they are maintained, can have a significant affect on the overall benefit of the facility for its owner. Consequently, great care is usually exercised in the design and operation of facilities. Unfortunately, because the construction of facilities are difficult to undertake, multiple organizations are often involved. The organizations involved must work closely with one another to ensure success. However, in the past, work that is performed early in the lifecycle of a facility has often gone unused or is otherwise unknown to other organizations that are responsible for the later phases of the lifecycle. Because later organizations are unaware of design decisions made, or why certain aspects of the facility were designed or constructed in a particular manner, decisions may be made by those later organization that have a less than optimal affect on the facility. There is, therefor, a need in the art for a system and method that enables close coordination of all phases of the lifecycle of a facility.

### SUMMARY OF THE INVENTION

The present disclosure relates to an apparatus, method and system for managing the lifecycle of a facility. The method provides an integration mechanism that enables the application of systems engineering methods to facilities, such as physical facilities, factories, and infrastructure projects. The integration mechanism is constructed and arranged to manipulate information related to the lifecycle of the facility. The lifecycle can concern any object, such as an individual physical facility or building, refinery, plant, or collection of facilities. Moreover, the apparatus, system and methods of the present invention are equally applicable to any endeavor that requires coordination between two or more organizations.

The apparatus disclosed herein provides a mechanism and enables methods for storing, retrieving and communicating information about an endeavor between elements of the same organization or with other organizations over a period of time, and throughout multiple phases of the lifecycle of the endeavor, such as, for example, a virtual facility and/or a physical facility. The phases may include defining the facility; creating and preparing the facility; operating the facility; and decommissioning the facility. The information used to define, to execute, and/or to operate the facility can be shared via the apparatus (mechanism). The apparatus consists of hardware and/or software that enable methods that can be employed by users to create a system that enables the lifecycle management of one or more phases of a facility.

The apparatus can be implemented with, for example, one or more digital computers having one or more processors. The processors of the computer are typically equipped with random access memory, as well as persistent storage, such as a hard disk drive. The apparatus can also be equipped with communications mechanisms, such as network interface cards, modems, keyboards, a mouse, monitor display, printers and the like. Network interfaces in particular enable the transmission of large amounts of information in relatively short periods of time. The apparatus can be connected to one or more networks to which one or more users of one or more organizations can be connected at any given time to form the system.

The method that is enabled by the system disclosed herein is capable of assisting in, or performing one or more steps associated with the phases of the lifecycle of the facility, such as evaluating the facility, proposing the facility, selecting the facility, designing the facility, procuring one or more parts for the facility, fabricating the facility, installing the facility, commissioning the facility, using (operating) the facility, maintaining the facility, and/or decommissioning the facility.

The apparatus and/or the system can employ one or more communication protocols that enable information technology systems of disparate organizations to communicate, regardless of the information system used by any particular users. For example, the protocol can be used to convey information from a first computer system to a second computer system, by one or more users within one or more organizations. Moreover, the apparatus disclosed herein can enable one or more methods that, when employed by one or more users or one or more organizations or one or more software applications, create a system that can operate and perform one or more activities or tasks.

### BRIEF DESCRIPTION OF THE DRAWINGS

A more complete understanding of the present disclosure and advantages thereof may be acquired by referring to the following description taken in conjunction with the accompanying drawings, wherein:

FIGS. 1a-1d are block diagrams illustrating the phases of a lifecycle of a facility according to the teachings of one embodiment of the present disclosure.

FIG. 2 is a block diagram illustrating the phases of a lifecycle of a facility upon which various management functions are superimposed according to the teachings of one embodiment of the present disclosure.

FIG. 3 is a block diagram illustrating the phases of a lifecycle of a facility upon which various management functions are superimposed according to the teachings of one embodiment of the present disclosure.

FIG. 4 is a block diagram illustrating management functions and enabling systems according to the teachings of one embodiment of the present disclosure.

FIG. 5 is a block diagram illustrating enabling functionality for a management system according the teachings of one embodiment of the present disclosure.

FIG. 6 is a block diagram illustrating multiple components of a build domain and a design domain according to the teachings of one embodiment of the present disclosure.

FIG. 7 is a block diagram illustrating a data model according to the teachings of one embodiment of the present disclosure.

FIG. 8 is a block diagram illustrating a distributed data system according to the teachings of one embodiment of the present disclosure.

FIG. 9 is a block diagram illustrating a facility lifecycle management system according to the teachings of one embodiment of the present disclosure.

FIG. 10 is a block diagram illustrating a facility lifecycle management system according to the teachings of one embodiment of the present disclosure.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The description herein provides two embodiments of the invention. It will be clear to those skilled in the art that, after reading this specification, many alternate embodiments are possible, and the embodiments disclosed herein are not meant to be comprehensive or exhaustive, but merely illustrative. The invention disclosed herein includes one or more methods that are enabled by the apparatus, that when used by one or more users, form a system that is able to plan, to define, to design, to build, to operate, to maintain, and/or to dispose of the result of the endeavor, such as a facility. The description herein describes the use of a chemical facility, wherein the term chemical can mean any chemical and/or hydrocarbon, and the chemical facility can process any such chemical and/or hydrocarbon, such as, for example, a facility capable of a producing, processing or manufacturing facility in the upstream oil & gas, petrochemical and/or refining. However, the methods, apparatus, and systems described herein have applicability to fields outside of the chemical and hydrocarbon markets. Examples of chemical facilities include, but are not limited to: onshore and offshore oil and/or gas facilities; onshore and offshore oil rigs; hydrocarbon refineries; petrochemical processing plants; chemical processing plants; liquefied natural gas facilities; gas to liquid facilities; ammonia production plants; ethylene production plants; phenol production plant; olefin production plants; polyolefin production facilities; paint production facilities; and pharmaceutical production facilities.

In one embodiment, a facility lifecycle management method supported by a highly integrated suite of work processes and supporting computing systems that can be applied throughout the lifecycle of a producing, processing or manufacturing facility in the upstream oil & gas, petrochemical and/or refining, power utilities, pulp and paper or commercial industries. Such an endeavor or project can be accomplished under the authority of a single entity called the “Prime Facilities Coordinator.” The Prime Facilities Coordinator has the responsibility and the ability to manage and to integrate the work activities that are performed by itself and/or others. The Prime Facilities Coordinator also has the ability to evaluate, to propose, to select, to define, to design, to procure, to fabricate, to install, to commission, to operate, to maintain, and/or decommission the one or more physical facilities in a safe, environmentally acceptable, predictable, cost-efficient manner that results in a high level of customer satisfaction.

The description of one or more of the methods disclosed herein can provide an overview of the features of the apparatus and system. One or more of the services described herein provide additional capabilities to the upstream oil & gas, petrochemical and refining, power utilities, pulp and paper or commercial industries that can be enabled by one or more of the methods described herein. The work processes described herein also provide new capabilities to the upstream oil & gas, petrochemical and refining, power utilities, pulp and paper or commercial industries when they are employed by one or more of the methods disclosed herein. The tools & computing systems described in this embodiment support and enable one or more work processes that support one or more methods that provide one or more services.

The facility lifecycle management apparatus, system and method have been developed to address several identified root causes of failure of the upstream oil & gas, petrochemical and refining, power utilities, pulp and paper or commercial industries to meet intended or predicted project outcomes in a consistent manner. While other causes of failure may be remedied by use of the invention disclosed herein, the identified root causes of failure include:
Business objectives of customers, prime service providers, and suppliers (secondary service, hardware, software providers) are not aligned.
Each project is a reinvention.
Requirements, planning, and scheduling ignore project constraints.
Change management is not efficient.
   The complexity of the problems and their root causes require a solution and methodology (work processes) that can be supported by a highly integrated suite of work processes and enabling computing systems. The solution also includes a key feature that continuously improves the work processes and enabling computing tools by incorporating project execution knowledge and ongoing research and development. The management of work processes, knowledge, research & development, and/or resource allocation for any project can be performed by an overarching organization that may be called the “Enterprise” with one or more exclusive functions (work processes, knowledge, research & development and/or resource allocation).

Methods

The methods disclosed herein improve communication in order to support the alignment of key stakeholders by providing a highly collaborative work environment in a visual and readily-accessible format. The project organization structure itself can be aligned with the definition of the structure for the physical facilities. The typical entities in the organization are the “Project Management Team,” the “Systems Engineering and Interface Management Team(s),” the “Facility Lifecycle Management Teams,” and/or the Enterprise Management Team. Customer and supplier representatives are integrated members of one or more of these entities to assure communication and alignment. Suppliers are required to agree to and follow the integrated supplier work process to qualify as team members. Such an arrangement eliminates one of the root causes of failure identified above.

The knowledge management capabilities incorporated within the method coupled with a facility requirements system (which contains original design intent) and a distributed, but highly integrated computing architecture allow subject matter experts to search historical designs and identify components, subsystems, and/or systems applicable for reuse on current Projects. Lessons, best practices, innovations and learning are collected and recycled into templates, tools and approaches that are made widely available, preventing the need to ‘start from scratch’ and building on past successes. The computing architecture also allows suppliers (hardware) to supply “standard” components in the system for reuse on future projects. This eliminates another of the root causes of failure identified above.

The method disclosed herein utilizes a formal systems engineering approach to requirements management that features a validation process with the customer to assure understanding of project requirements and constraints thus providing a process for customer alignment, an allocation process with prime service providers (which could be Prime Facilities Coordinator personnel) and suppliers (secondary service, hardware, software providers) in order to provide coherent and concise requirements that specify the statement of work that can be to be accomplished, thereby providing a process for supplier alignment and a verification process that ensures that the requirements have been met. Such an arrangement provides a tangible process for demonstrating customer satisfaction. The requirements defined above are used by subject matter experts to generate statements of work for the project or endeavor that are then linked in a work process precedence model, the “Integrated Plan.” Allocated resources are linked to the Integrated Plan so that an “Integrated Schedule” can be created. The requirements management system identifies some of the technical risks that could be addressed by a formal risk management process. Other risk sources include contractual issues, schedule constraints and/or project execution risks. The risk management process identifies, quantifies and schedules the work activities (that are also included in the Integrated Plan and the Schedule) that can mitigate the risks to an acceptable level. Such an arrangement helps to eliminate one or more of the root causes identified above.

A formal change management process can be included in the method described herein to manage changes in customer requirements and/or derived requirements (that are either generated internally by the Prime Facilities Coordinator personnel and/or by the suppliers). The system also enables the management of changes identified during the execution of the statement of work. This method disclosed herein can use various levels of “Change Review Boards” to assess the validity and the impact of a change in requirements on the statement of work. The method also provides clear traceability between the change in requirements and their impact on the project's cost and schedule. Such traceability facilitates customer understanding of the impact of changes and provides an efficient process for deciding whether to incorporate any or all of the changes to the statement of work. The method thus precludes another root cause of failure identified above.

The facility lifecycle management methods disclosed herein enable the provision of one or more services to the upstream oil & gas, petrochemical and refining, power utilities, pulp and paper or commercial industries.

One or more of the services can be characterized by the management and integration of the work activities of a producing, processing or manufacturing facility or other facilities over its lifecycle by the Prime Facilities Coordinator. Provision of services does not preclude the Prime Facilities Coordinator from providing additional services to the upstream oil & gas, petrochemical and refining, power utilities, pulp and paper or commercial industries during the development of the producing, processing or manufacturing facility including but not limited to: field development planning (upstream oil & gas specific), conceptual engineering, detailed engineering, procurement management, construction management, commissioning, operation optimization, and maintenance optimization services.

Work Processes

The work processes to be applied in support of the facility lifecycle management method described herein are useful to the upstream oil & gas, petrochemical and refining, power utilities, pulp and paper or commercial industries, as well as other industries and markets. The work processes include the application of a facility lifecycle management “Facility Based Execution Organization” work process (methodology) that tailors the organization structure of the Prime Facilities Coordinator to the components of the structure for the physical facilities required. The work processes described herein delivers an organizational structure that includes a Project Management Team, a single or multiple “Systems Engineering & Interface Management Team(s)” and multiple “Facility Lifecycle Management Teams” any or all of which can have a focus on managing interfaces between the organization entities. The work processes may require the inclusion of customers and/or integrated suppliers as team members in the execution organization. One of the features of the organization work processes disclosed herein is a Project Management Team that can be very flexible and responsive to changes in statements of work due to changes in requirements that affect project schedule, cost and lifecycle value components. The flexibility and responsiveness is due, in part, to the effective implementation of formal “Requirements Management,” “Integrated Planning” and “Change Management” methodologies (these are described below) and are also due to the granting of authority, accountability and responsibility of maturing the lifecycle phases of the required physical facilities to the “Systems Engineering & Interface Management Team(s)” and the “Facility Lifecycle Management Teams” which allows the Project Management Team to focus on project schedule, cost and lifecycle value issues and customer satisfaction issues.

Another feature is the “Systems Engineering & Interface Management Team(s)” that provide expert analyses resources, a facilities specific requirements management work processes, which includes a requirements verification plan and a set of customer validated performance requirements for the facilities, a facilities specific configuration management plan, a facilities specific technical risk management plan, a facilities specific interface management plan, a facilities specific statement of work and a facilities specific “Integrated Plan” to the “Facility Lifecycle Management Teams” in order to facilitate the execution of their work activities.

Another feature is the “Facility Lifecycle Management Teams,” whose number and individual scope can be determined by the “Systems Engineering & Interface Management Team(s)” based on the specific components of the structure for the physical facilities of a given project. Each “Facility Lifecycle Management Team” has the authority to mature the lifecycle phases (mentioned above) of their portion of the facility's structure as they see fit given the project-specific constraints of the Project Management Team. As such, the Facility Lifecycle Management Team incorporates a facility lifecycle design work processes that can consider operability and maintainability of their portion of the facility, as well as one or more focal areas which consider procurement, Health, Safety and Environment and construction issues. The application of a continual “Lifecycle Value” measurement model can be employed to guide the teams during the execution of their statement of work. Each team can be responsible for executing their statement of work and accountable for the completion of their statement of work per the “Integrated Plan.” The application of the Facility Based Execution Organization work processes described above addresses one of the root causes of failure described above.

Another feature of this disclosure is the application of a rigorous systems engineering discipline work process (methodology) termed “Requirements Management”. Requirements Management work processes can be applied at the business level and the facility level. Business level requirements would be specific to the requirements that are related to the business objectives of a given project and facility level requirements would be specific to the requirements that are related to the definition of the physical facilities. The Requirements Management work processes can be to be applied throughout the physical facilities' lifecycle and can be initiated at the first lifecycle phase, i.e., during the definition of the development and exploitation strategies of the asset in terms of proposing multiple concepts of physical facilities. The work processes includes the organization of customer requirements, the validation of these requirements with the customer, the allocation of these requirements to the appropriate entities (subject matter experts) which use these requirements to create their statement of work and who derive additional requirements based on execution of their work and the verification that the requirements have indeed been met in the entities work product. The application of the “Requirements Management” work processes addresses one or more of the root causes of failure identified above.

Another feature disclosed herein is the application of a rigorous systems engineering discipline work process (methodology) termed “Integrated Planning.” Integrated Planning work processes can be applied at the business level and the facility level. The Integrated Planning work processes can be applied throughout the physical facilities' lifecycle and can be initiated when the requirements for a given project are suitably mature. Once the requirements are suitably mature, they are used by subject matter experts to generate statements of work for the project or endeavor that are then linked in a work process precedence model, the “Integrated Plan.” The Integrated Plan is a method that can logically identify, connect and/or integrate the functional activities that can be associated with performing the work for the facilities lifecycle. The Integrated Plan enables one or more users and/or organizations to collaborate on the definition of the statement of work. Resource allocations can be linked to the Integrated Plan so that the “Integrated Schedule” may be created. Due to the hierarchy of relationships, the changes in requirements that have been approved and validated are able to be tracked directly to effect statements of work, which in turn affects the Integrated Plan and finally affects the associated Integrated Schedule. The application of the “Integrated Planning” work processes addresses one or more of the root causes of failure identified above.

Another feature disclosed herein is the application of a rigorous “Change Management” work process (methodology). The Change Management work processes can be integrated with the Requirements Management work processes. The Change Management work processes can provide for the inclusion of “Change Review Boards” and the inclusion of “Design Element Freeze” during the detailed engineering lifecycle phase of the facilities. The Change Management work processes can be applied to any portion or throughout the physical facilities' lifecycle and can be initiated when the requirements for a given project are suitably mature. The Change Management work processes provides the flexibility to tailor the “rigor” of the work process based on the lifecycle phase of the facilities. For example, during the definition phase of a facility's lifecycle, the Change Management work process can be made simpler and does not require as many levels of change review and approval as does the portion of the Change Management work process that can be applied during the execution phase. The application of the Change Management work processes addresses one or more of the root causes of failure identified above.

Another feature disclosed herein is the application of a modified “3D Conceptual” work process. This 3D Conceptual work process can be highly collaborative and flexible in nature and leverages the reuse of historical project data. A modified 3D Conceptual process can be called the “Rapid Concept” work process. The Rapid Concept work process can be made by modifying the 3D Conceptual process in two significant areas. First the 3D Conceptual process can be modified to allow the simultaneous definition of detailed design, procurement, construction and operating & maintenance domains during this same phase of the facilities'lifecycle. After the selection of the preferred concept can be made to include provision for decisions and information created by this work process to be directly usable during the defining of the preferred concept to the extent required to facilitate the decision whether or not to commit funds to further pursue the development strategy. The Rapid Concept work process can be applied during the definition of the development strategy of a producing, processing or manufacturing facility in the upstream oil & gas, petrochemical and refining, power utilities, pulp and paper or commercial industries in terms of proposing multiple concepts of physical facilities required to meet the development strategy, selecting the preferred concept, and defining the preferred concept to the extent required to facilitate the decision whether or not to commit funds to further pursue the development strategy. The Rapid Concept work process may also be applied during the execution phase of the facilities' lifecycle, when changes in requirements for the facilities are identified by the Requirements Management and Change Management work processes are deemed severe enough (e.g., create unacceptable risk) to warrant additional concept proposals for affected components of the physical facilities. The application of the Rapid Concept work processes addresses one or more of the root causes of failure identified above.

Another feature disclosed herein is application of an “Aligned Suppliers” work process (methodology). The Aligned Suppliers work processes, in part, creates a truly integrated and aligned supplier pool that provides a continuous relationship maintenance process at the program/enterprise/endeavor level. The integrated and aligned supplier pool can be utilized at the project level for suppliers of all types of commodities, physical commodities and/or the provision of commodity services. Engagement of integrated suppliers can be initiated during the definition of the development and exploitation strategies of the asset, in terms of proposing multiple concepts of physical facilities that are required to exploit the asset. The number and involvement of the Integrated Suppliers may increase or decrease continually during the selection of the preferred concept. The involvement of the Integrated Suppliers in the step of defining the preferred concept, to the extent required to facilitate the decision of whether to commit funds or to pursue the development and exploitation strategy, culminates during the execution phase. While involvement of the Integrated Suppliers may continue through later phases of the endeavor, they may be reduced greatly during the operation phase of the facility's lifecycle. The primary activities of the Integrated Suppliers may be limited to recommending and consulting during the initial operation, the modifications (as required) and the maintenance of the physical commodities or commodity services. The application of the Aligned Suppliers work processes addresses one or more of the root causes identified above.

Another feature disclosed herein is the application of an “Object Engineering” work process. The Object Engineering work process utilizes a status attribute to determine a data maturity level for each object throughout the object's lifecycle. An object can be defined as a component in the physical facility, such as a pipe, instrument, valve or piece of equipment. The status of the object can be used to aid the management of progressing work, to help eliminate bottlenecks in one or more designs, and/or the procurement and the construction work processes by notifying downstream users of the status of an object's data maturity level. Notification of the object's status can provide an indication of the risk level of using an object with immature data to progress work, and/or to obtain an indication of the project's progress measurement by the “rolling up” of all the objects' statuses. The modified work process can be called the “Object Lifecycle Management” work process (methodology). Object Lifecycle Management work processes can be applied to facilitate the management of lifecycle phases of individual components, subsystems, systems and major facility areas that comprise the physical facilities. The work process described above can be modified in two significant areas. First, the Object Lifecycle Management work process can be applied to not only individual components, but to subsystems, systems and major facility areas (all are considered objects) of the physical facilities. Secondly, the Object Lifecycle Management work process can begin at an earlier in the facility's lifecycle phase and can be maintained throughout the remaining facility's lifecycle phases. The Object Lifecycle Management work process can be initiated during the selection of the preferred concept phase and can continue through to the decommissioning of the facilities. The application of the Object Lifecycle Management work processes addresses one or more of the root causes of failure identified above.

Another feature disclosed herein is the application of a “Reapplication Design” work process (methodology). The Reapplication Design work processes provides for the inclusion of “integrated template designs” that apply to subsystems and systems of the physical facilities and facilitate the rapid lifecycle maturation of those subsystems and systems and the inclusion of integrated suppliers that can provide standard physical component-type commodities that facilitate the reapplication of those standard components during the definition and execution (primarily the detailed engineering phase) lifecycle phases of the physical facilities. The application of the Reapplication Design work processes addresses one or more of the root causes identified above.

Another feature disclosed herein is the application of an “Authoritative Geometry Based Work Package” work process (methodology). The Authoritative Geometry Based Work Package work processes provides for the inclusion of the concept for an authoritative source for data concerning the facilities geometric definition. The authoritative source for facilities geometry information will be the virtual three-dimensional models of the physical facilities. The Authoritative Geometry Based Work Package work processes includes combining selected portions of the facilities structure (this can be as small as a single component) from the models with an extract of the applicable requirements from the Requirements Management system for the same selected portions of the facilities structure to create the basis of a statement of work for that specific Authoritative Geometry Based Work Package. As such, the resulting coherent and concise definition of the statement of work can then be transmitted to appropriate Facility Lifecycle Management Team (the leader of which could be an external supplier of services and not an entity of the “Prime Facilities Coordinator” corporate organization) for execution. The application of the Authoritative Geometry Based Work Package work processes addresses one or more of the root causes identified above.

Another feature disclosed herein is the application of an “Authoritative Geometry Based Construction” work process (methodology). The Authoritative Geometry Based Construction work processes provides for the inclusion of a novel dimensional control strategy utilizing laser based metrology technology that focuses on the measurement key physical facility elements and comparison of those measurements to the same important elements as designed and contained in the virtual three dimensional model (the model can be considered to be the authority for facilities geometry information). Based upon the comparison, construction execution strategies can be formulated and acted upon in a timely and efficient manner. The application of the Authoritative Geometry Based Construction work processes addresses one or more of the root causes identified above.

Another feature is the application of an “Integrated Build Plan” work process (methodology). Integrated Build Plan work processes utilizes the virtual three-dimensional model for virtual build simulations before actual fabrication and installation occur. This work processes allows problems in the build precedence plan (the sequencing of fabrication and installation events) to be uncovered and corrected prior to the onset of fabrication. The build plan can then be integrated with design activities and can drive changes in the design to facilitate the maximization of facilities lifecycle value. The application of the Integrated Build Plan work processes addresses one or more of the root causes identified above.

Another feature disclosed herein is the application of a “Risk Management” work process (methodology). The Risk Management process identifies, quantifies and schedules the work activities (these are also included in the Integrated Plan and Schedule) required to mitigate the risks to a predetermined acceptable level. Other risk sources include contractual issues, schedule constraints and/or project execution risks. The application of the Risk Management work processes addresses one or more of the root causes identified above.

Another feature disclosed herein is the application of a “Knowledge Management” work process (methodology). The Knowledge Management work processes can identify relevant and necessary knowledge, capture the knowledge to a repository, provide easy accessibility to that knowledge, and provide self-service and facilitated approaches for transferring that knowledge to users and/or other systems. The Knowledge Management work processes includes the planning of appropriate initiatives, piloting them, expanding them up to enterprise-wide implementation and then, ultimately, achieving full-scale institutionalization as an integrated and measurable aspect of the culture. The application of the Knowledge Management work processes addresses one or more of the root causes identified above.

Tools & Computing Systems

As stated earlier, the facility lifecycle management method can be supported by an integrated suite of work processes and supporting computing systems. Several of the work processes in the integrated suite that have been described above are supported and enabled by several computing systems.

The computing systems to be applied to enable the work processes disclosed herein that support the facility lifecycle management method can be classified as follows:
The system of computing systems that support the highly integrated suite of work processes, i.e., the new computing system architecture.
The application of an individual computing tool, or several computing tools, to the upstream oil & gas, chemical, petrochemical and refining, power utilities, pulp and paper or commercial industries support and improve existing work process.

The apparatus disclosed herein can be implemented using one or more software applications on one or more computer systems. For example, the DOORS application can be a requirements management tool manufactured by Telelogic. DOORS can be designed to capture, to link, to trace, to analyze and to manage changes to information to ensure a project's compliance to specified requirements and standards. The DOORS computing tool will be used primarily to enable the application of a rigorous systems engineering discipline work process (methodology) termed Requirements Management. DOORS will also secondarily support the applications of the Change Management, Risk Management, Authoritative Geometry Based Work Package and Integrated Planning methodologies.

The apparatus disclosed herein can utilize an existing computing tool or several existing computing tools to support and to enable work processes that are new to the upstream oil & gas, petrochemical and refining, power utilities, pulp and paper or commercial industries. For example, the apparatus disclosed herein can use the FieldPlan application, which can be a personal computer based expert system offered by Granheme that can be used for field development planning of oil and gas prospects. The FieldPlan computing tool can be used secondarily to support the Rapid Concept work processes described above. The primary use of the FieldPlan tool can be to support the legacy work activity for field/asset planning in the offshore oil & gas domain. Similarly, the apparatus disclosed herein can use the EWarehouse application, which can be an object-oriented data warehouse offered by Bentley Systems. EWarehouse enables users to manage effectively the assets having lifecycles of 30 years or more. EWarehouse consolidates and integrates data from other information technology (“IT”) systems to create a central data store, accessible by, for example, a desktop PC and/or Internet applications, or the like. EWarehouse can be used to collect data from engineering environments, thereby creating a project database for handover to the owner-operator. In turn, the owner-operators can use EWarehouse to associate the asset's engineering data with information collected automatically from other systems, such as systems for maintenance management, document management, enterprise resource planning, or accounting. The EWarehouse computing tool can be used to enable the applications of the Rapid Concept, Reapplication Design and Object Lifecycle Management methodologies.

Another software tool is the Primavera P3e/c. Primavera can be a planning and scheduling tool that can be tailored for the specific needs of the engineering and construction industries. The Primavera computing tool can be used to enable the application of the “Integrating Planning” work processes.

Another available software tool is called CADView 3D. CADView 3D can be a web-based multi-user 3D geometry viewer offered by Oracle. CADView 3D allows real-time interrogation of a facility's product structure, components and components' attributes, shared real-time mark-up, shared sectioning, shared animation for assembly sequencing or plant walkthroughs. The CADView 3D computing tool can be used to enable the application of the Rapid Concept work processes.

Another tool that can help implement the apparatus disclosed herein is the Enovia LCA. This computing tool will be used primarily to enable the application of the “Reapplication Design”, “Authoritative Geometry Based Construction”, “Authoritative Geometry Based Work Package” methodologies and secondarily to enable the application of the “Integrated Build Plan” work processes.

Another tool that can help implement the apparatus disclosed herein is called Delmia. The Delima computing tool can be used to enable the application of the Integrated Build Plan work processes.

Another tool that can help implement the apparatus disclosed herein is called KIPS. KIPS is offered by Kellogg Brown & Root, Inc. and is a smart, schematic generation tool. KIPS utilizes the drawing engine found in VISIO (manufactured by the Microsoft Corporation of Redmond, Wash.) and the graphic icons are linked to a Microsoft SQL Server database (also manufactured by the Microsoft Corporation). The KIPS integrated computing system can be used to enable the application of the Rapid Concept work processes and to enable the application of the Reapplication Design work processes.

Other tools that can help implement the apparatus disclosed herein are called Plantwise, Plantbuilder and Autorouter which can be a plant or facility layout and pipe auto-router offered by Design Power. Plantwise, Plantbuilder and Autorouter computing tools can be used to enable the application of the Rapid Concept work processes and to enable the application of the Reapplication Design work processes.

Another tool that can help implement the apparatus disclosed herein is called KCIM. KCIM is offered by Kellogg Brown & Root, Inc. and is a cost index generation tool. The KCIM tool takes input from either KIPS and/or Plantwise Plantbuilder & Autorouter. With that input, KCIM generates relative cost indices for various conceptual design options. KCIM can be used to enable the application of the Rapid Concept work processes.

Another tool that can help implement the apparatus disclosed herein is the Catia V5. The Catia computing tool can be used to enable the application of the Reapplication Design, the Authoritative Geometry Based Construction, the Authoritative Geometry Based Work Package and/or the Integrated Build Plan methodologies.

Another tool that can help implement the apparatus disclosed herein is the FieldPlan application, which is offered by Granheme's and is a personal computer based expert system used for field development planning of oil and gas prospects. FieldPlan provides real-time economic assessment of oil and gas opportunities ranked by user-defined economic criteria. FieldPlan provides comprehensive reports based on minimal field information with the ability to select development preferences and adjust detail requirements for increasing levels of accuracy. FieldPlan can evaluate prospects in up to 12,000-foot water depths and generate potential development scenarios by considering technically feasible configurations of wells, subsea architectures, production facilities and export options. It has its own database for calculating costs of various components. The database can be updated annually to reflect the market conditions and thirteen geographical areas of the world.

The apparatus, methods and system described herein thus provides value for the facility lifecycle management of small and/or large scale integration throughout the lifecycle of a producing or manufacturing facility in the upstream oil & gas, petrochemical and refining, power utilities, pulp and paper, chemical and/or commercial industries, under the authority of a single entity, such as the Prime Facilities Coordinator. The value of the methods and system disclosed herein can be derived, in part, by the increased project management responsiveness and control through the use of the Facility Based Execution Organization, Requirements Management, Integrating Planning, Change Management, Risk Management and Object Lifecycle Management methodologies and other enabling tools, work processes and computing systems.

Another value of the apparatus, system and methods disclosed herein can be due to the increase in project definition and project execution efficiency made possible by the use of the Knowledge Management, Rapid Concept, Reapplication Design, Aligned Supplier, Integrated Build Plan, Authoritative Geometry Based Work Package and Authoritative Geometry Based Construction methodologies and enabling tools and computing systems.

Another value component derived from the apparatus, system and methods described herein can be the leveraging of legacy methodologies and enabling tools and computing systems to span the lifecycle of the implementation of the strategy to develop the producing, processing or manufacturing facility ensuring a continuity of alignment of customer, prime service providers and suppliers and the ability to make strategic decisions based on maximizing lifecycle value. Examples of these methodologies and associated enabling tools are field/asset planning (enabling tool such as FieldPlan) which allows early economic assessment of oil and gas development opportunities, VALUE FINDER (offered by Kellogg Brown & Root, Inc.) which provides a quantified operational performance assessments for physical facilities and REAL TIME OPERATIONS (offered by Kellogg Brown & Root, Inc.) which provides real time decision support for maximizing operational performance and minimizing operation and maintenance costs.

VALUE FINDER is systematic value improvement process that finds opportunities to identify value in the operations and maintenance of customer's facilities and engages the customer's field and support staff in delivering maximum value to their organization. VALUE FINDER is a software program that can be used to identify both best practices and gaps in the performance of a facility. Information and data can be gathered from research and interviews and used to identify and understand the business drivers and goals. This analysis can then be used to develop recommended actions to effectively enhance the facility.

REAL TIME OPERATIONS is a communications portal based decision support business process, knowledge management and asset performance monitoring system for the effective operations and maintenance of an asset. The system facilitates a clear line of sight through an organization, from the asset performance goals to the actions that deliver them at all levels and across all functions within the organization. These performance metrics and the supporting actions can be seen by anyone, anytime at anywhere on the globe giving the whole business process for an operation to be clearly viewed and managed. The system comprises an integrated business management process which can be delivered “real time” through a portal technology medium. An asset can be defined as a producing or manufacturing facility in the upstream oil & gas, petrochemical and refining, power utilities, pulp and paper or commercial industries. In all cases, the asset will have sources of data that can be used to more effectively describe the performance of the asset in terms of cost, throughput, uptime, energy efficiency and product quality. The sources of data can be from any supervisory control systems or databases associated with client enterprise management systems. Typically these data sources are used independently and not brought into one common interface in order to view the whole assets performance as well as the performance of the functional groups that support operations. REAL TIME OPERATION'S analysis algorithms and data extraction processes leverage the reservoir of data that exists in production facility supervisory control systems and client enterprise management systems. These applications extract key performance information including production loss/deferment and loss causation information, as well as equipment uptime performance, in order to make more informed decision making within operations and maintenance support teams. Real time asset performance information tapped from control systems and other information sources are brought together in a novel “line of sight” management system designed to be the operations and maintenance support control panel or “dashboard”. Communications portal technology may also be harnessed to enable a “real time” access medium for production and maintenance management information. The benefits delivered to a support organization, can be the ability to focus support teams efforts on value based decisions and to measure their alignment with asset goals. Asset performance can be viewed form any part of the global on any individual's desktop and enable remote subject matter experts to support any operation cost effectively.

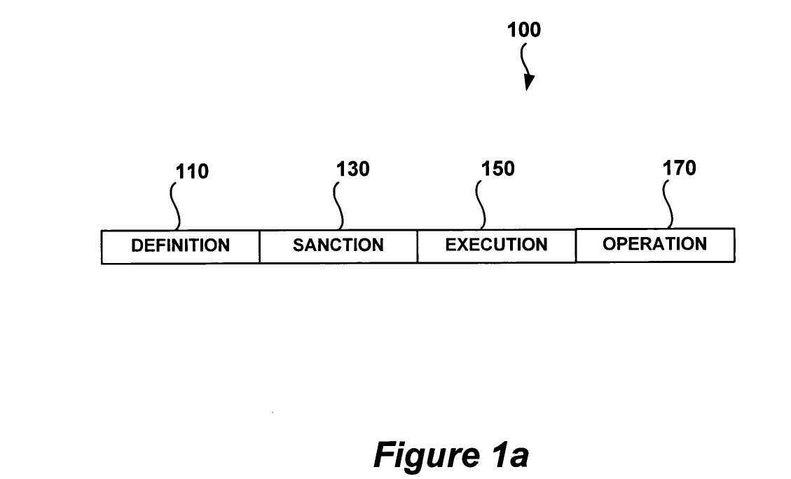

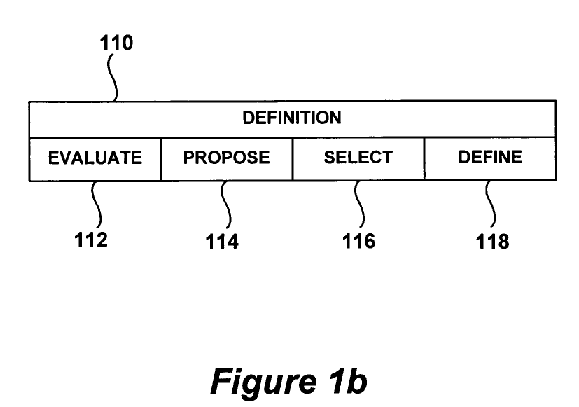

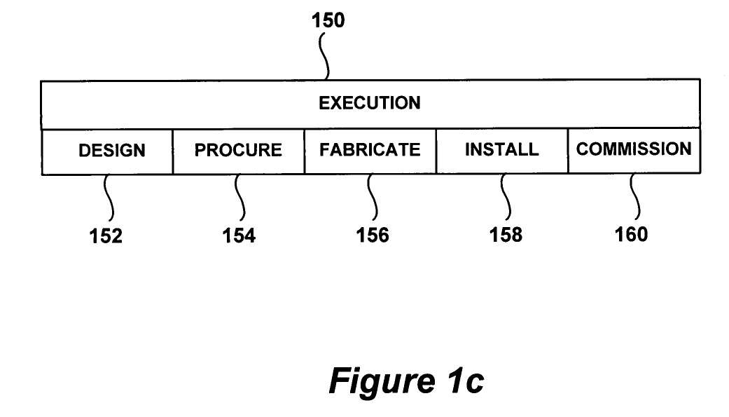

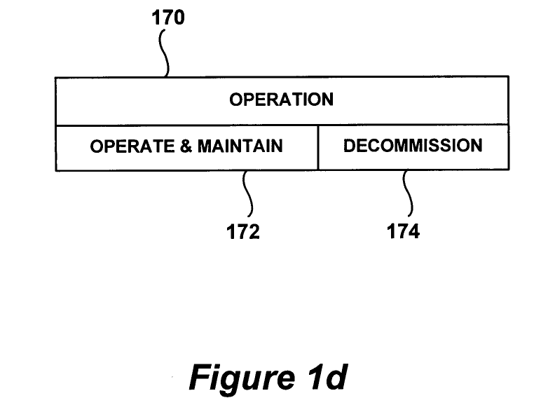

Referring now to the drawings, FIGS. 1 through 10 illustrate an embodiment according to the teachings of the present invention. FIGS. 1a-1d are illustrative of exemplary phases of a lifecycle of a facility. The illustrative embodiment disclosed herein contemplates the construction and use of a physical facility, such as a process plant. However, the teachings disclosed herein are equally applicable to any endeavor that requires coordination among groups of users and/or among one or more users over a period of time. The invention disclosed herein includes one or more methods that are enabled by the apparatus, that when used by one or more users, form a system that may be able to plan, to define, to design, to build, to operate, to maintain, and/or to dispose of the result of the endeavor, such as a facility.

In general, in one embodiment, the lifecycle 100 has, for example, four major phases, such as, the definition phase 110, the sanction phase 130, the execution phase 150 and the operation phase 170. Each of the main phases of the lifecycle 100 itself can have several components. For example, the definition phase 110 can include the evaluate phase 112, the propose phase 114, the select phase 116, and the define phase 118. Each of the sub-phases within a larger phase can last a defined or an unspecified period, and may encompass one or more functions. Time may not be the figure of merit for any particular phase or sub-phase. Typically, but not always, data maturity or data definition may define the completion of the sub-phase and/or the phase. For example, the evaluate phase 112 can be used for evaluating what type of facility or facilities would need to be constructed to meet the customer's requirements; what the facility would be used for; what are the needs within the particular industry both currently and at some future date within the proposed or the expected lifecycle of such a facility. The next phase can be the proposal phase 114, during which the evaluated needs and desires for the facility are proposed to the organization that would invest in the facility. The proposal phase 114 may generate one or more alternate proposals that meet the needs and/or the desires for the facility that can be the focus of the endeavor. Under the teachings of the present disclosure, the knowledge that was gained during the evaluation phase 112 can be used (via the apparatus and system discussed later) for the proposal phase 114. Similarly, in the select phase 116, the various facility configuration options that are made by one or more organizations during the propose phase 114 are presented, and one or more of those configuration options are selected, perhaps for further study and/or definition. Typically, a single proposal can be selected for further study. In the define phase 118, one or more selections from the previous select phase 116 may be used to further define the exact nature and characteristics of one or more preferred facility configurations. In the next portion of the lifecycle 100, namely the sanction phase 130, the decision to complete the design of a selected proposal, to construct and to utilize the facility can be made.

If the facility is desired and the proposed plan can be approved, then the execution phase 150 begins. The execution phase 150 itself can be composed of various phases, such as the design phase 152, the procurement phase 154, the fabrication phase 156, the installation phase 158, and the commission phase 160. The design phase 152 can be utilized for making the design definition of the facility so that all of its parts, subcomponents, and/or main assemblies needed to construct the facility can be purchased. The procurement phase 154 can be used to purchase, gather and procure one or more of the parts, sub-components and/or main assemblies that are needed to construct the facility. In addition, in the procurement phase 154, contracts can be let out for other elements of the facility so that those elements can be added to the facility later.

In the fabrication phase 156, the parts, subcomponents and/or assemblies that were procured or produced during the procurement phase 154 will be taken to the various sites where the facility can be to be constructed, and fabrication of the facility begins. During the installation phase 158, various components of the facility, such as tooling, production equipment, office equipment and other incidental items needed to use the facility for its intended purpose are installed into the facility itself. Alternatively, for offshore facilities, the various components of the facility can be marshaled to a particular location and then shipped and/or airlifted to the offshore location for installation. Finally, the execution phase 150 can be concluded with the commissioning phase 160. During the commissioning phase 160, any final arrangements needed to make the facility operational are made.

Once the facility has been commissioned, then the operation phase 170 can commence. The operation phase 170 itself can have one or more sub-phases, though most typically there will be simultaneous operation and maintenance phase 172, and the decommission phase 174. During the operation and maintenance phase 172, the facility can be operated to conduct its intended activity, such as the production of goods and services. Finally, when the facility is no longer desired, the decommission phase 174 can be initiated. During the decommission phase 174, for example, whatever can be salvageable from the facility may be taken, sold or parceled off to other facilities and the physical facility itself can be made safe for other uses, is demolished, dismantled, or is otherwise abandoned.

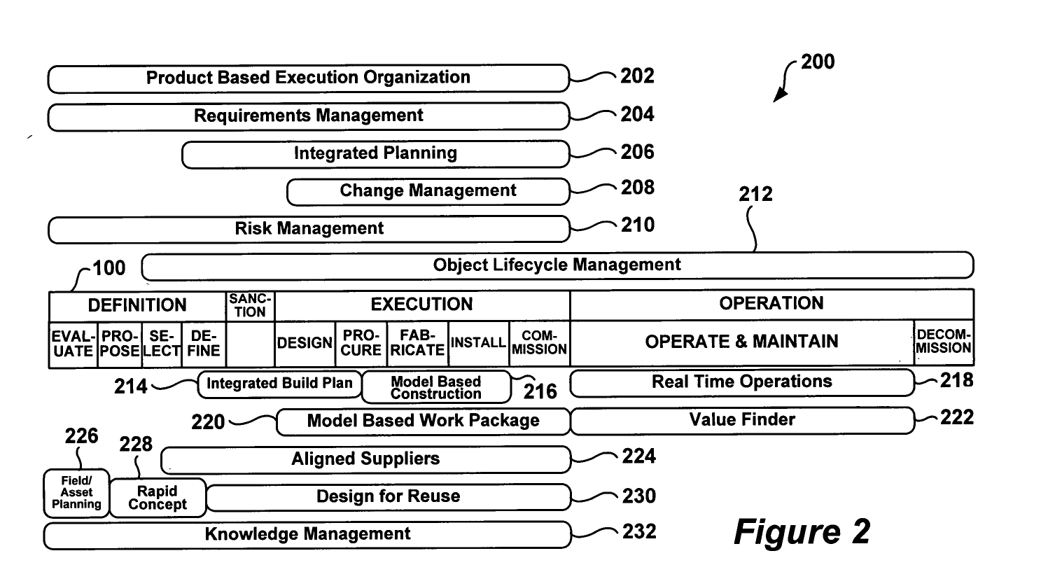

FIG. 2 is a block diagram illustrating the ancillary activities associated with the lifecycle 100 a facility. The lifecycle 100 for a facility can be superimposed with various ancillary activities that are conducted during one or more of the phases or sub-phases of the lifecycle 100. For example, during the definition phase 110, the sanction phase 130, and the execution phase 150 of the lifecycle 100, the product-based execution organization 202 are active. Similarly, the activities of the requirements management organization 204, the integrated planning organization 206, the change management organization 208, the risk management organization 210 and the object lifecycle management organization 212 may operate during the definition 110, sanction 130 and/or operation 150 phases of the lifecycle 100 as illustrated in FIG. 2. Similarly, other aspects of management organizations that may be active during the lifecycle 100 include the integrated build planning organization 214, the model-based construction activity 216, the real-time operations 218, the model-based work package 220, the VALUE FINDER™ 222, the aligned suppliers activity 224, the field/asset planning activity 226, the rapid concept activity 228, the design for reuse activity 230 and the knowledge management activity 232 may all be active during various phases and sub-phases of the lifecycle 100. In many cases, as illustrated in FIG. 2, various activities may be performed in parallel as opposed to other activities, such as the integrated build plan and the model based construction that may be accomplished in a sequential fashion. Similarly, the activities can be performed by one or more users, by one or more organizations, and/or by one or more software applications that perform the functions needed to accomplish the particular activity. For example, the Real Time Operations can be accomplished by an organization which may use the Real Time Operations software application mentioned previously. As will be understood by those skilled in the art, various activities within the lifecycle 100 can be performed by one or more groups of people and/or one or more organizations, any or all of whom can use one or more software applications. Moreover one or more of the software applications can operate autonomously to perform one or more of the functions that perform part or all of the particular activity. Moreover, the activities identified in FIG. 2 may be named differently, or the allocation of tasks and/or functions of the activities and organizations depicted herein may be allocated differently, without departing from the spirit of this disclosure, or from the scope of the appended claims.

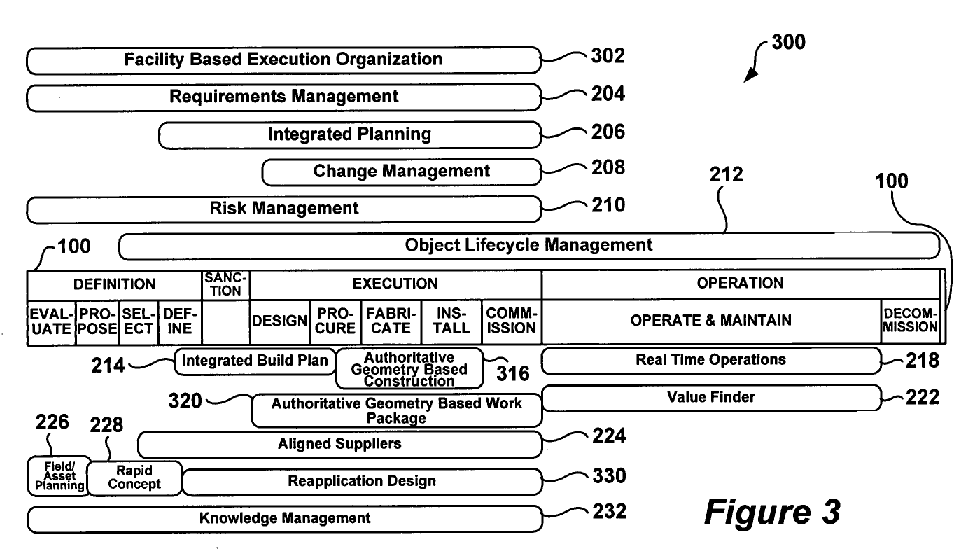

FIG. 3 illustrates an alternate embodiment illustrating the ancillary activities associated with the lifecycle 100 of a facility. The activities 300 can share many of the same activities components as illustrated in FIG. 2. For example, the lifecycle 100 can be superimposed with various activities and organizations, 204, 206, 208, 212, 210, 214, 218, 222, 226, 228, 224 and 232. However, other activities, such as facility-based execution organization 302, the authoritative geometry-based construction organization 316, the authoritative geometry-based work package activity 320 and the reapplication design organization 330 may all be active during the lifecycle 300. While the various activities illustrated in FIG. 3 are generally performed in the definition 110, sanction 130 or execution 150 phases of the lifecycle 100, it will be understood that various elements of the work processes illustrated in FIGS. 2 and 3, or other work processes can be reformed at other phases of the lifecycle 100 such as the operation phase 170.

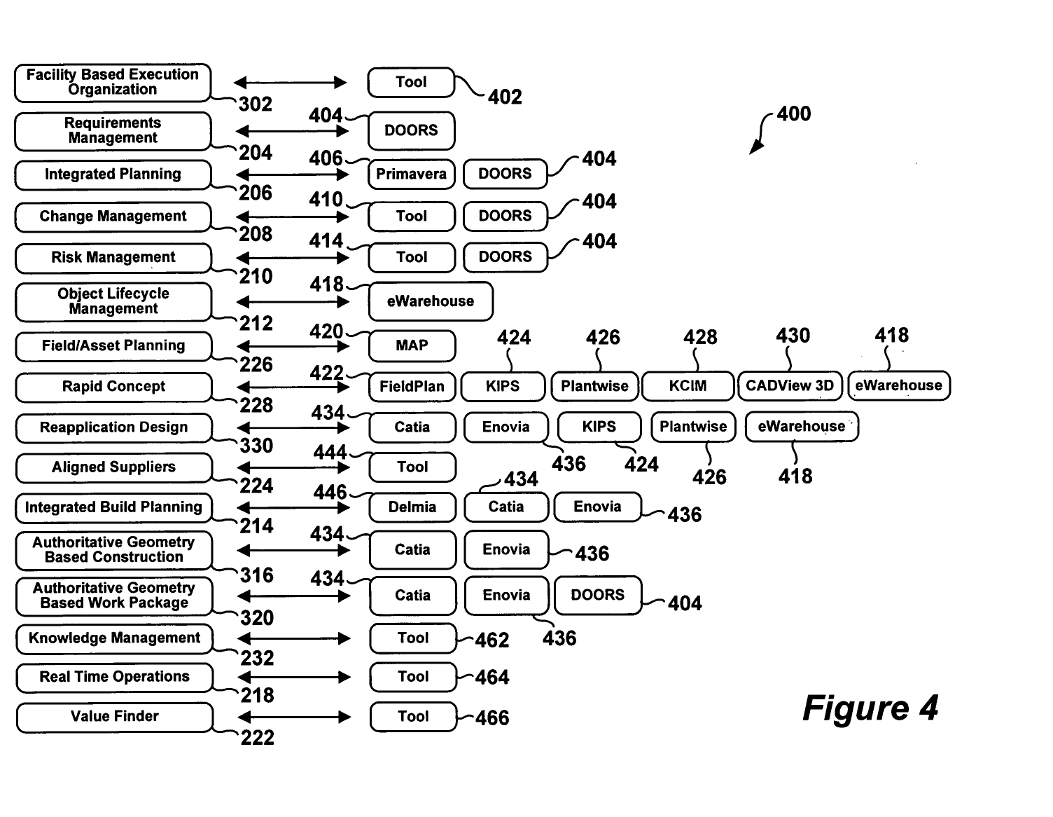

FIG. 4 is a block diagram that illustrates the various organizations and activities as well as the software tools that are used to support those organizations and activities. On the left side of FIG. 4 are various activities and organizations that are involved in the endeavor. Specifically, the organizations and activities may include one or more of the following: the facility based execution organization 302, the requirements management organization 204, the integrated planning organization 206, the change management organization 208, the risk management organization 210, the object lifecycle management organization 212, the field/asset planning organization 226, the rapid concept organization 228, the reapplication design organization 330, the aligned suppliers organization 224, the integrated build plan organization 214, the authoritative geometry based construction organization 316, the authoritative geometry based work package 320, the knowledge management organization 232, the real time operations organization 218, and the value finder organization 222. Each of the processes, activities and/or organizations noted above are supported by a variety of hardware and/or software tools disclosed herein. For example, the facility-based execution organization 302 can be supported by tool 402. Similarly, the requirements management organization 204 can be, in one embodiment, supported by the DOORS software application 404. The integrated planning organization 206 can use, for example two tools namely, the Primavera application 406 as well as the DOORS application 404. Similarly, the change management organization 208 and the risk management organization 210 can use the DOORS application 404 as well as tools 410 and 414, respectively. The object lifecycle management organization 212 can use the eWarehouse application 418. The field/asset planning organization 226 can use the MAP application 420. The rapid concept organization 228 can use a wide variety of the tools and applications such as, for example, the FieldPlan application 422, the KIPS application 424, the Plantwise application 426, the KCIM application 428, the CADView 3D application 430 and the eWarehouse application 418. The order in which these various applications are illustrated in FIG. 4 is not indicative of their necessity, or sequence of operation. These applications are merely listed here to illustrate the various software applications that can be used to facilitate, for example, one or more planning aspects of the lifecycle facility management method.

The reapplication design process 330 also can have several supporting applications such as the Catia application 434, the Enovia application 436, the KIPS application 424, the PlantWise application 426, and/or the eWarehouse application 418. The aligned suppliers organization 224 can be supported by tool 444 as illustrated in FIG. 4. The integrated build planing organization 214 can be supported for, by example, the Delmia application 446, the Catia application 434 and the Enovia application 436. Similarly, the authoritative geometry-based construction organization 316 can be supported by the Catia application 434 and the Enovia application 436 and/or the Delmia application 446. The authoritative geometry-based work package 320 can be supported by, for example, the Catia application 434, the Enovia application 436, the Delmia application 446, and/or the DOORS application 404. The knowledge management organization 232 can be supported by tool 462. Similarly, the real time operations organization 218 and the value finder organization 222 can be supported by tools 464 and 466, respectively as illustrated in FIG. 4.

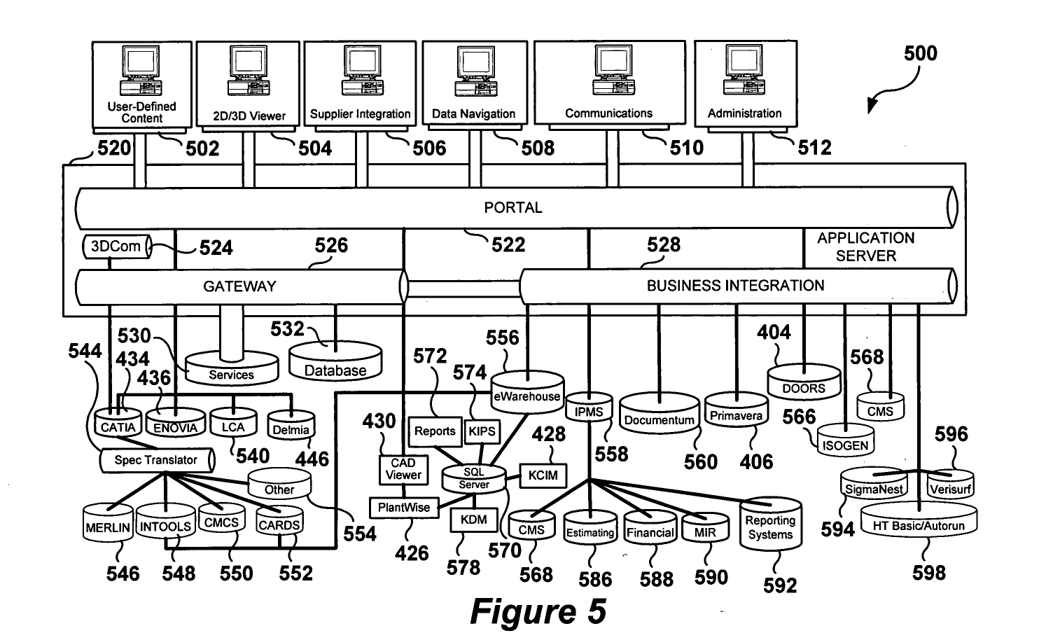

FIG. 5 is a block diagram of the elements, such as, for example, software processes and computer systems (hardware) that are used in conjunction with one embodiment of the methods and systems disclosed herein. The supporting elements for the present invention can utilize various broad-based architectural techniques—such as client server applications and/or web-based applications, or other types of computer software architectures. FIG. 5 is an illustration of a web-based application utilizing the Internet as a transport medium. Other types of transport media, such as virtual private networks (“VPN”), standard telecommunication land-lines and modems, etc., can be utilized with lesser, equal or greater effect. In this illustrative example, multiple users can view and utilize user-defined content 502 on a personal computer using a web browser that interacts with the portal 522, perhaps in a secure manner. Similarly, users can access the 2D/3D Viewer 504 that enables viewing of, for example, drawings, charts and models of the facility, perhaps in a secure manner. The supplier integration access point 506 enables third-party suppliers and vendors (as well as other users) to interact with information stored within the system 500 via the portal 522, perhaps in a secure manner. The interaction enabled by the system 500 enables vendors and third parties (among others) to gather the information they need to fulfill contracts and to provide parts and supplies for the facility that can be the subject of the endeavor. The interaction contemplated for supplier integration can utilize a proprietary protocol, a standard protocol, or multiple (open and/or proprietary) protocols and data formats. The data navigation feature 508 can be a convenient way for users to access information within the system 500 by, for example, initiating word searches. The communication feature 510 facilitates communication between two or more organizations (or within the same organization) by enabling communications protocols (such as email, instant messaging and the like). The system 500 may also be enabled to record the communication traffic for later retrieval and analysis. The portal administration feature 512 enables users external to the system 500 to administrate the application server 520, or other aspects of the system 500.

In the illustrative example of FIG. 5, all users access the web application server 520 through, for example, the portal 522. The application server 520 and the portal 522 are supported by one or more software applications and/or hardware systems. FIG. 5 illustrates the operative relationship of various features and applications of the system 500, such as the gateway 526 and the business integration application 528. The gateway 526 can also be supported by, for example, gateway services 530 and the database 532. The database 532 can be a single database application, a database engine or, for example, a database farm having multiple database applications on one or more computer servers. The gateway 526 and the portal 522 may also be supported by the Enovia application 436 as well as the Catia application 434. The Catia application 436 can also support the 3DCom application 524 as illustrated in FIG. 5. The LCA 540 and the Delmia application 446 can also support both the gateway 526 and the portal 522 as illustrated in FIG. 5. The Catia application 434 can also be supported by the specification translator 544. The specification translator 544 itself can be supported by the Merlin application 546, the Intools applications 548, the CMCS application 550, the CARDS application 552 as well as other applications 554. Some of these applications (tools) can be also cross-integrated with other applications. For example, the Intools application 548 and the CARDS applications 552 can be used to support the eWarehouse application 556. The operative coupling of the two applications can be via, for example, direct hardware wiring, communication protocol (via, for example, the gateway 526 and the business integration application 528 as illustrated in FIG. 5) and the like. Other applications can support the portal 522. For example, the CAD Viewer 430, which itself can be supported by the PlantWise application 426, can be used to support the portal 522. Similarly, the database server 570 can be used as a database application that can support, for example, the reports application 572 for generating reports about the status of, or information within, the system 500. Similarly, the KIPS application 574 the KDM Application 578, and the KCIM application 428 can support the database server 570, and thus any other element of the system 500. The KCIM application 428 can be supported by the database server 570. Finally, the database server 570 can also support, for example, the eWarehouse application 418 as illustrated in FIG. 5. The business integration application 528 can be supported by, for example, the IPMS application 558, the documentum application 560, the Primavera application 406, the DOORS application 404, the ISOGEN application 556 and the completion management system (“CMS”) application 568. A second (or the same) CMS application 568 can be used to support the IPMS application 558 as illustrated in FIG. 5. Similarly, the estimating application 586, the financial application 588, the MIR application 590, and the reporting systems application 592 can also support the IPMS application 558 as illustrated in FIG. 5. Finally, the business integration application 528 can also be supported by the SigmaNest application 594, the Verisurf application 596 and the HT Basic/Autorun application 598.

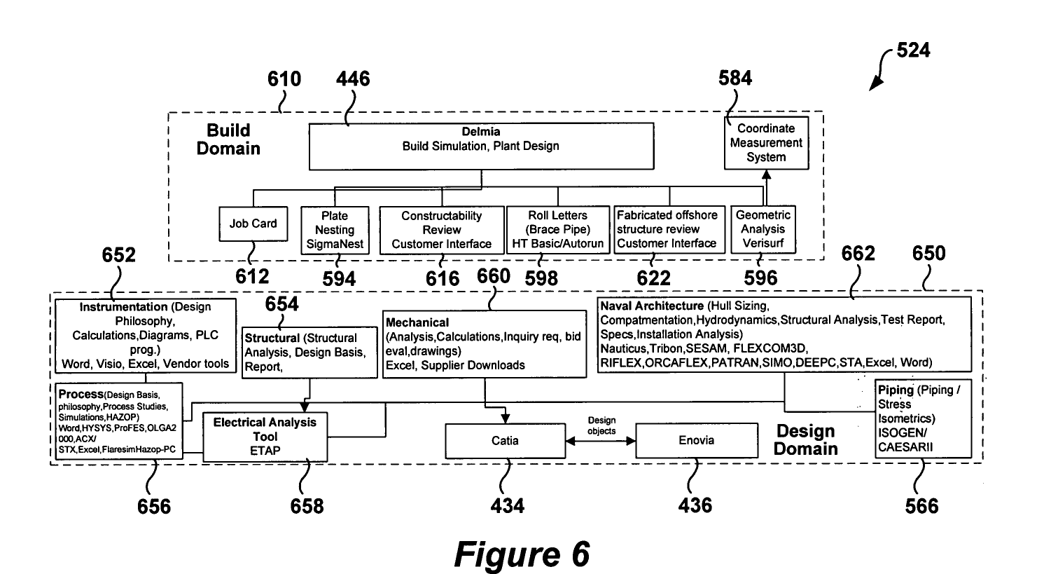

FIG. 6 illustrates an example of some of the interactions of various applications illustrated in FIGS. 4 and 5 that can be used during multiple phases of the lifecycle 100. As illustrated in FIG. 6, there are two domains, namely the design domain 650 and the build domain 610. Within the build domain 610, multiple applications are utilized in the build process. For example, the Delmia application 446 can be used for build simulation and plant design. The Delmia application 446 can also be used in conjunction with, for example, the Job Card application 612, the SigmaNest application 594, the constructability review customer interface 616, the HT Basic/Autorun application 598, the fabricated offshore structure review customer interface 622, the Verisurf application 596—the latter of which may also supply information to or from the coordinate measurement system 584 as illustrated in FIG. 6. The design domain 650 can comprise, for example, the instrumentation component 652, the structural component 654, the mechanical component 660, the naval architecture component 662, the process component 656, the electrical analysis tool (“ETAP”) 658, the Catia application 434, the Enovia application 436, and the ISOGEN application 566.

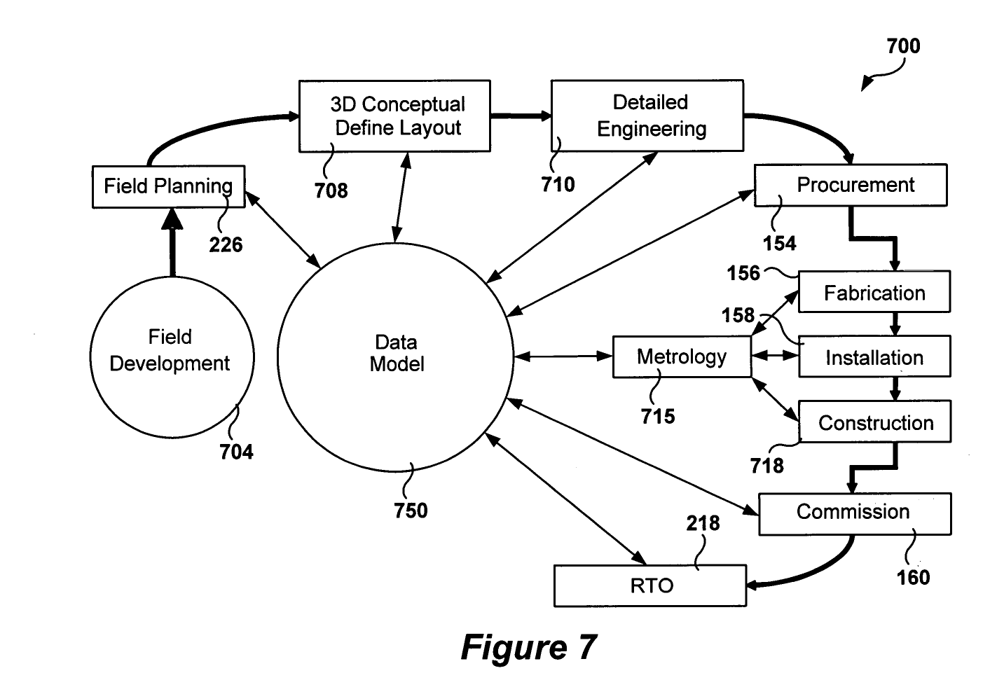

FIG. 7 illustrates one embodiment of the interaction of the data model 750 with the method 700 for use with multiple phases of the lifecycle 100 of a hydrocarbon or other mineral or resource field development. In the middle of FIG. 7, the data model 750 is illustrated. While the data model 750 can be centrally located within FIG. 7, the database that implements the model 750 need not be centrally located and can be, for example, a distributed process on a computer network system (not shown). The data model 750 can be, and in this embodiment is intended to be, accessible by large numbers of users, processes, applications, and organizations. At the beginning of the method 700, there can be a field development activity 704 which culminates into a field planning activity 706 (associated with the field/asset planning organization 226). After the field planning activity 706, there can be a conceptual define layout activity 708, which may be followed by a detailed engineering activity 710. Thereafter the procurement phase 154 can be entered, followed by the fabrication phase 156, an installation phase 158, and a construction phase 718 that may be part of the installation phase 158. Normally, the commission phase 160 follows the installation phase 156. A real-time operation activity 722 may be performed by the real time operations organization 218 and may occur during the operation phase 170 (see FIG. 1). As illustrated in FIG. 7, the data model 750 enables each of the steps of the method 700 to obtain (or store) data that can be either provided to or be extracted by other steps within the method 700. Part of the data gathering process may be facilitated by the metrology process 715 in which measurements are taken during the procurement phase 154, the fabrication phase 156, the installation phase 158 and/or the construction phase 718, such as, for example, measurements taken by laser scanning devices. The measurements taken by the metrology process 718 during either the procurement phase 154 and/or the fabrication phase 156 can be stored in the data model 750 and used during the installation phase 158 and/or the construction phase 718. Some features of metrology are: validating physical features or interfaces of parts, subcomponents and/or assemblies prior to construction to verify that the purchased item will fit properly when assembled, validating the final “as constructed” physical features or interfaces for the purposes of final facility verification. Thus, minor changes that are dissimilar from the original facility plan can be recorded and that information can be provided to subsequent processes, particularly in the maintenance aspect so that information that appears to deviate from previous plans can be understood as changes during the fabrication, installation and/or construction phases. As illustrated in FIG. 7, information that is needed during any phase of the method 700 can be obtained from the data model 750. Similarly, information that can be gathered during each of the phases can be saved to the data model 750 for use in later phases of the lifecycle 100.

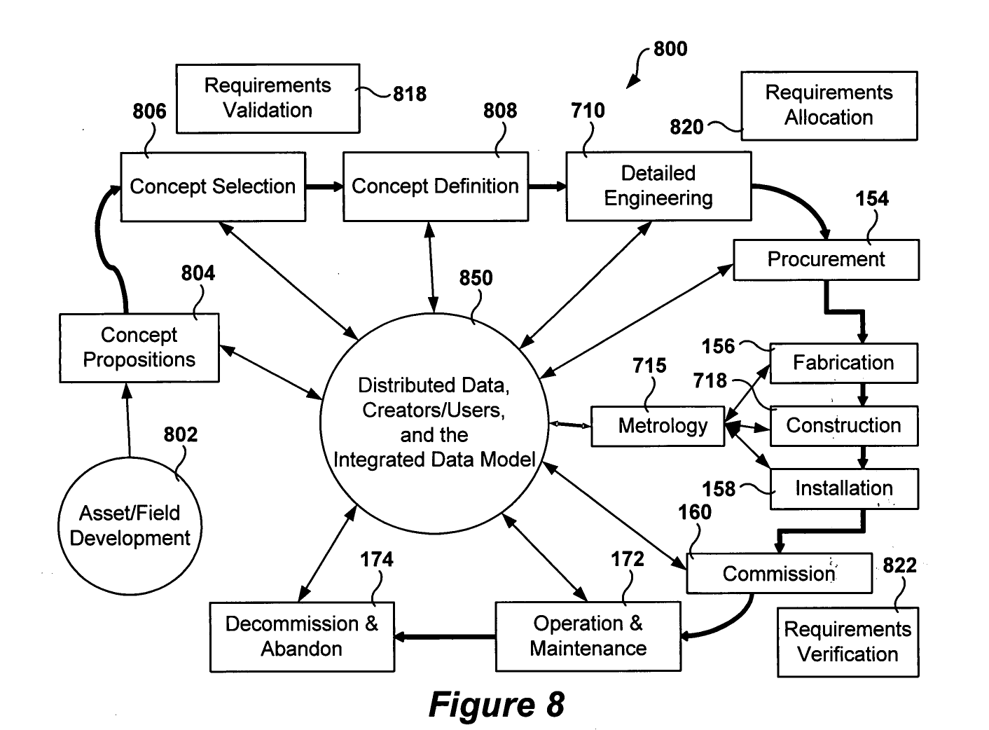

FIG. 8 illustrates the strategy model 800 that can be an alternate method of employing various elements and phases of the present disclosure. In the case of the model 800, there can be distributed data that can be available for use by creators, users and the integrated data model 850. The work processes used in conjunction with the strategy model 800 starts with the asset/field development phase 802 that can be associated, for example with the asset/field planning organization 226. A concept propositions phase can be conducted in step 804 where propositions are created regarding the concept for the desired facility. Thereafter, a concept selection phase can be commenced in step 806. The concept definition phase can be conducted in step 808. A detailed engineering phase can be conducted in step 710 (see FIG. 7) that can be followed by the procurement phase 154 (see FIG. 1). It should be noted that there might be a requirements validation activity in step 818 and a requirements allocation activity in step 820 that can be operative with the integrated data model 850. After the procurement phase 154, there can be a fabrication phase 156, a construction phase 718 and/or an installation phase 158. The fabrication, construction and installation phases 156, 718 and 158, all use or can use the metrology step 715 for storage and retrieval of measurements taken during one or more phases. After the installation phase 158, the commission phase 160 may be conducted, which can then be followed by the operation and maintenance sub-phase 172 of the operation phase 170. After the operations and maintenance sub-phase 172 has been completed, the decommission and abandonment phase 174 can be performed. Finally, there may be a requirements verification step 822 that may be similar to the requirements verification step of FIG. 7. The requirements verification step 822 may occur during one or more phases, but typically culminates during the initial operation of the facility. In any of the sub-phases 804, 806, 808, 710, 154, 156, 718, 158, 160, 172 and 174, software and/or hardware that can be used to support or implement those steps may interact with the data model 850 to store and/or to retrieve information in the data model 850.

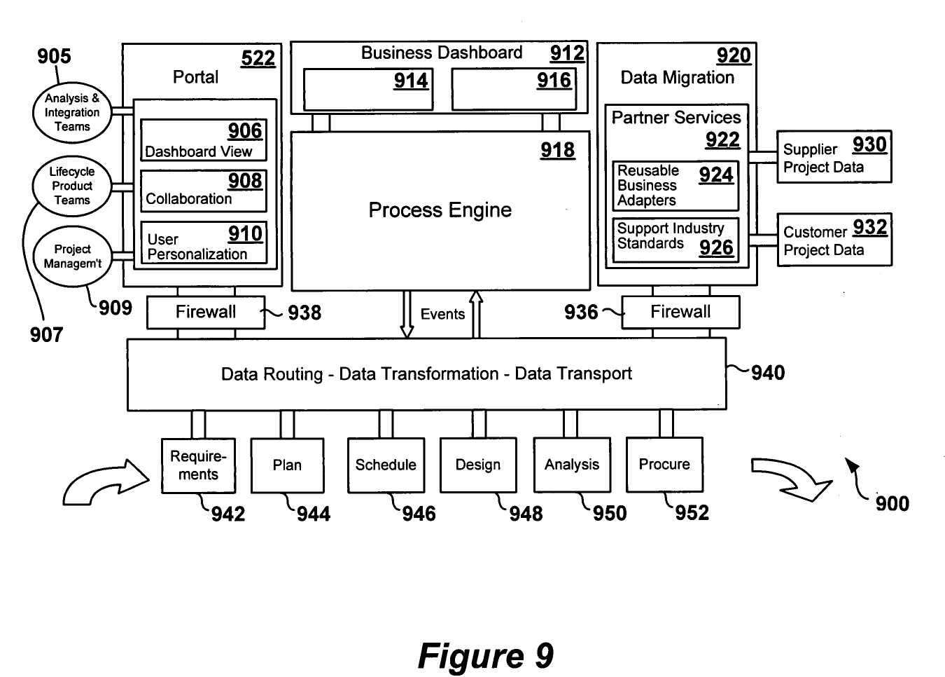

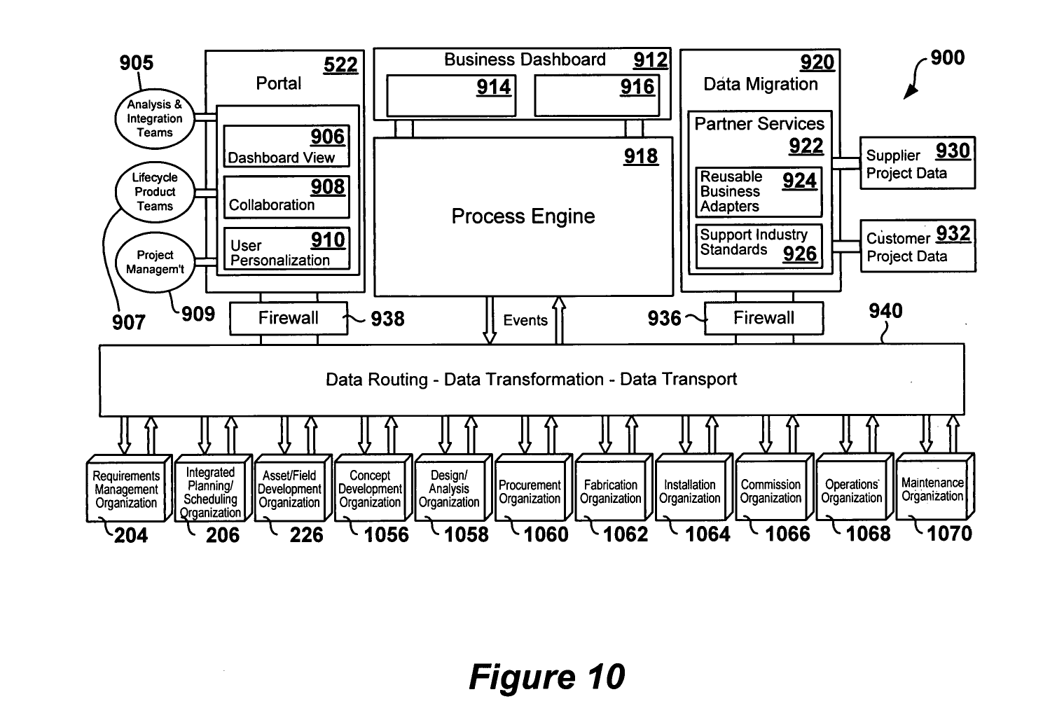

The system 900 may comprise one or more components as illustrated in FIGS. 9 and 10. For example, the system 900 includes the portal 522, a business dashboard application 912, a data migration application 920, the process engine 918 and the transport layer 940. The business dashboard application 912 can contain one or more applications or display mechanisms that convey the status or performance of the apparatus and/or the system. For example, the dashboard application 912 can convey performance business data 914 and/or workflow statistics 916 or the like. The transport layer 940 can be used for interaction with requirements activities 942, planning activities 944, scheduling activities 946, design activities 948, analysis activities 950 and procurement activities 952. While described in this embodiment as activities, they may also be described as functions that perform one or more operations or the like. One or more of the activities 942, 944, 946, 948, 950 and 952 may occur during the lifecycle 100 and can interact with the transport layer 940 using common formats and protocols or disparate formats and protocols. The transport layer 940 can be constructed and arranged to interact with the process engine 918 and/or the data migration application 920 and/or the portal 522. The transport layer may simply pass through an appropriately protocoled message, or it can translate the message from the received protocol into a common protocol that can be useful for the system 900. The requirements activity 942, planning activity 944, the scheduling activity 946, the design activity 948, the analysis activity 950 and the procurement activity 952, can all interact with the transport layer 940 as illustrated in FIG. 9. The transport layer 940 can be constructed and arranged to modify, if necessary, the protocols and/or formats used with the various processes supporting activities 942 through 952, or to pass through an acceptable protocol to the portal 522, the process engine 918 and/or the data migration application 920. In one embodiment disclosed herein, firewalls 936 and 938 may be provided that filter, if necessary, data or communication signals between transport layer 940 and the data migration application 920 and the portal 522, respectively. Events (such as signals, messages and/or other triggers) are typically processed directly between the transport layer 940 and the process engine 918 as illustrated in FIG. 5, although events can be routed through the portal 522 and/or the data migration application 920. Analysis and integration teams 905 can interact with, for example, the portal 522 using, for example, the dashboard view 906. Similarly, lifecycle product teams 907 can use, for example, the collaboration applications 908 of the portal 522. Project management teams 909 can use the user personalization application 910 of the portal 522. The data migration application 920 can include partner services 922 which itself can include one or more business adapters 924 and support for industry standards 926. The adapters 924 and the standards support 926 can be used with, for example, the supplier project data 930 and the customer project data 932. The supplier project data 930 can include, for example, scheduling information, component definitions, integration requirements and the like. The customer project data 932 can include field data, historical data, operations and maintenance data, key decisions made, changes made (or contemplated), deliverables (or lists thereof) and performance information.

FIG. 10 shows many of the elements of FIG. 9 (and the above-description applies equally for the same elements). However, FIG. 10 illustrates how the data transport layer 940, and thus the system 900 can be used with other organizations, functions and/or processes, such as the requirements management organization 204, the integrated planning/scheduling organization 206, the field/asset development organization 226, the concept development organization 1056, the design/analysis organization 1058, the procurement organization 1060, the fabrication organization 1062, the installation organization 1064, the commission organization 1066, the operations organization 1068, and the maintenance organization 1070.

The foregoing description of the embodiments of the invention has been presented for the purposes of illustration and description. The foregoing description is not intended to be exhaustive, or to limit the invention to the precise form disclosed. Many modifications and variations are possible in light of the above teaching. It is intended that the scope of the invention be limited not by this detailed description, but rather by the claims appended hereto.

1. A method for managing the lifecycle of a chemical facility comprising:
providing an integration mechanism, the integration mechanism constructed and arranged to manipulate information related to the lifecycle; and
defining the facility;
wherein the information used to define the facility is shared by the integration mechanism.

2. The method of claim 1, wherein the step of defining includes evaluating the facility.

3. The method of claim 1, wherein the step of defining includes proposing the facility.

4. The method of claim 1, wherein the step of defining includes selecting the facility.

5. The method of claim 1, wherein the integration mechanism has a communication protocol.

6. The method of claim 5, wherein the protocol is used to convey information from a first computer system to a second computer system.

7. The method of claim 1 further comprising:
executing the facility;
wherein the information used to execute the facility is shared by the integration mechanism.

8. The method of claim 7, wherein the step of executing includes designing the facility.

9. The method of claim 7, wherein the step of executing includes procuring one or more parts for the facility.

10. The method of claim 7, wherein the step of executing includes fabricating the facility.

11. The method of claim 7, wherein the step of executing includes installing the facility.

12. The method of claim 7, wherein the step of executing includes commissioning the facility.

13. The method of claim 1 further comprising the step of:
operating the facility;
wherein the information used to operate the facility is shared by the integration mechanism.

14. The method of claim 13, wherein the step of operating includes using the facility.

15. The method of claim 13, wherein the step of operating includes maintaining the facility.

16. The method of claim 13, wherein the step of operating includes decommissioning the facility.

17. The method of claim 1, wherein the chemical facility is a hydrocarbon chemical facility.

18. The method of claim 1, wherein the method supports Field Asset Planning.

19. The method of claim 1, wherein the method supports Rapid Concept.

20. The method of claim 1, wherein the method supports Object Lifecycle Management.

21. The method of claim 7, wherein the method supports Object Lifecycle Management.

22. The method of claim 13, wherein the method supports Object Lifecycle Management.

23. The method of claim 13, wherein the method supports Real Time Operations.

24. The method of claim 13, wherein the method supports Value Finder.
